(19) United States
(12) Patent Application Publication
(10) Pub. No.: US 2010/0106874 A1
(43) Pub. Date: Apr. 29, 2010

(54) Packet Filter Optimization For Network Interfaces

(76) Inventors: Charles Dominguez, Redwood City, CA (US); Brian Tucker, San Jose, CA (US)

Correspondence Address: APPLE INC./BSTZ;BLAKELY SOKOLOFF TAYLOR & ZAFMAN LLP, 1279 OAKMEAD PARKWAY, SUNNYVALE, CA, 94085-4040, US

(21) Appl. No.: 12/260,061

(22) Filed: Oct. 28, 2008

(51) Int. Cl. G06F 13/24

(52) U.S. Cl. 710/260

(57) ABSTRACT

A method and apparatus to reduce the transaction overhead involved with packet I/O on a host bus without sacrificing the latency of packets of important traffic types is described. This involves determining whether a packet is to be aggregated in response to receiving the packet in a receive buffer. If it is determined that the packet should not be aggregated, a host system may be interrupted to indicate availability of the received packet. Subsequently, the packet may be forwarded to an interrupted system via a local bus directly from a receiving buffer without being stored in a local storage. If it is determined that a packet is to be aggregated, it may be stored in a queue in local storage. Subsequently, it may be sent to a host system with a group of other frames using a single bus transaction to eliminate overhead.

### FIELD OF INVENTION

The present invention relates generally to network interfaces. More particularly, this invention relates to optimizing bus utilization and I/O performance through the use of enhanced packet filtering and frame aggregation.

### BACKGROUND

Network packets are typically transported between a network interface device and a host system via a local bus. Usually, a network interface device is designed to immediately forward received packets to a host processor in an attempt to reduce latencies incurred due to the buffering and the transportation of packets over a local bus. Although some types of network traffic, such as downloading a file, may not be sensitive to slight increases in latency, such delay may not be tolerated for many real time applications, such as voice over IP applications or receipt and display of video data.

A common practice of a network interface design is to start sending a packet to a host once the packet is received over a network. This minimizes the latency incurred by each packet. However, performing a separate transaction for each packet maximizes the proportion of I/O resources wasted on transaction overhead, and results in poor bus utilization. In addition, the number of operations required to retrieve packets from a network interface device may overload a host processor if each packet is sent by a separate transaction.

Alternatively, a network interface device may buffer each incoming packet and forward a group of packets together (e.g. glomming) to a host processor such that the number of bus transactions is reduced and the bandwidth of a local bus can be better utilized. Unfortunately, this increases the latency of the buffered packets. Mixing packets with different latency requirements together in a buffer may unnecessarily sacrifice high priority/low latency applications.

Therefore, current network interface peripherals do not efficiently transport received network packets over a local bus to a host processor.

### SUMMARY OF THE DESCRIPTION

In one embodiment, a method and apparatus are described herein to determine whether a packet is to be aggregated in response to receiving the packet in a receive buffer. If the packet is determined not to be aggregated, a host system may be interrupted to indicate availability of the received packet. An interrupt may be sent to a host processor of a host system over a local bus. Subsequently, a packet may be forwarded to an interrupted system via a local bus directly from a receive buffer without being stored in a local storage. In one embodiment, the determination of whether to aggregate the packet is based upon the class of the packet, as determined from the type of the packet and/or control information about the packet. If the packet is to be aggregated, then it will then be stored in a local storage before being transmitted to the host processor, and no interrupts will be asserted for that packet.

Other features of the present invention will be apparent from the accompanying drawings and from the detailed description that follows.

### BRIEF DESCRIPTION OF THE DRAWINGS

The present invention is illustrated by way of example and not limitation in the figures of the accompanying drawings, in which like references indicate similar elements and in which:

FIG. 1 is a block diagram illustrating one embodiment of system components to filter and aggregate packets;

FIG. 2 is a block diagram illustrating one embodiment of system components of a network peripheral to filter and aggregate packets;

FIG. 3 is a block diagram illustrating one embodiment of system modules to filter and aggregate packets;

FIG. 4 is a flow diagram illustrating an embodiment of a process to interrupt a host processor for sending non-aggregated packets;

FIG. 5 is a flow diagram illustrating an embodiment of a process to filter packets;

FIGS. 6A and 6B are flow diagrams illustrating embodiments of a process to forward aggregated packets to a host processor;

FIG. 7 illustrates one example of a typical computer system which may be used in conjunction with the embodiments described herein;

FIG. 8 shows an example of another data processing system which may be used with one embodiment of the present invention.

### DETAILED DESCRIPTION

A method and an apparatus for determining whether a packet is to be aggregated in response to receiving the packet in a receive buffer are described. In the following description, numerous specific details are set forth to provide thorough explanation of embodiments of the present invention. It will be apparent, however, to one skilled in the art, that embodiments of the present invention may be practiced without these specific details. In other instances, well-known components, structures, and techniques have not been shown in detail in order not to obscure the understanding of this description.

Reference in the specification to “one embodiment” or “an embodiment” means that a particular feature, structure, or characteristic described in connection with the embodiment can be included in at least one embodiment of the invention. The appearances of the phrase “in one embodiment” in various places in the specification do not necessarily all refer to the same embodiment.

The processes depicted in the figures that follow, are performed by processing logic that comprises hardware (e.g., circuitry, dedicated logic, etc.), software (such as is run on a general-purpose computer system or a dedicated machine), or a combination of both. Although the processes are described below in terms of some sequential operations, it should be appreciated that some of the operations described may be performed in different order. Moreover, some operations may be performed in parallel rather than sequentially.

The term “host” and the term “device” are intended to refer generally to data processing systems rather than specifically to a particular form factor for the host versus a form factor for the device.

According to certain embodiments, a network interface device may selectively determine if a network packet received should be aggregated in a local queue temporarily. A packet not aggregated may be forwarded to a host system over a local bus without delay. Thus, the latency for a packet not aggregated is minimized. Packets stored in a queue may be grouped together into a large frame or a blob (binary large object) to be forwarded to a host system in a single data transaction across a local bus. Consequently, the overall transaction overhead is minimized as the number of transaction operations required by a host processor is reduced. The reduction in transaction overhead improves bus utilization, decreases CPU utilization, improves overall I/O performance and also can decrease power usage. In one embodiment, whether a packet is aggregated depends on latency and/or priority requirements of the application or network protocols associated with the packet.

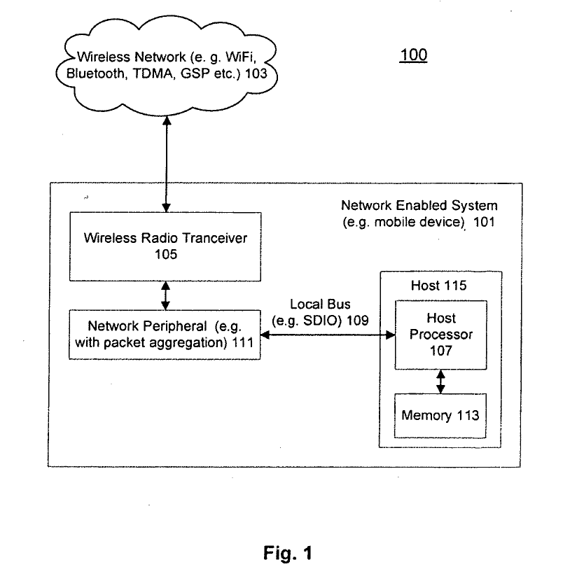

FIG. 1 is a block diagram illustrating one embodiment of system components to filter and aggregate packets. System 100 may include a network enabled system 101, such as, for example, a mobile device, a handset, a cell phone or a personal digital assistant, connected to a wireless network 103, such as, a WiFi (Wireless Fidelity) network, a Bluetooth network, or a TDMA (Time Division Multiple Access) network, etc., via a wireless radio transceiver 105. In some alternative embodiments, network 103 is a wired network, such as a wired Ethernet network and the transceiver 105 is a wired transceiver. A wireless radio transceiver 105 may receive packets from a wireless network 103 into a network peripheral 111 of a networked system 101. A packet may be a data packet or a network packet. In one embodiment, a packet includes a block of formatted data, such as a series of binary bits, carried over a network as a unit. A network peripheral 111 may be a chip set or a chip including a network interface processor to filter received packets.

In one embodiment, a network enabled system 101 includes a host 115 performing data processing operations including providing multiple layers of network services, such as, for example, network layers, transport layers, session layers, presentation layers and/or application layers, etc. Network services at an application layer may include an HTTP (Hyper Text Transfer Protocol) service, an FTP (File Transfer Protocol) service, a VOIP (Voice Over IP) service, or other applications. A host 115 may include an interrupt enabled host processor 107 coupled to a host memory 113. In one embodiment, a network peripheral 111 forwards packets received from a transceiver 105 to a host 115 via a local bus 109, such as an SDIO (Secure Digital Input Output) bus. A network peripheral 111 may issue an interrupt to a host processor 107 via a local bus 109 while packet data is being retrieved over the local bus 109.

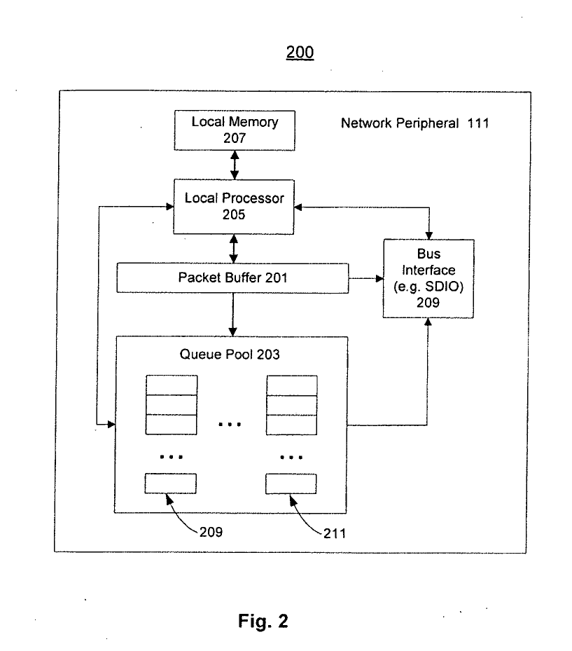

FIG. 2 is a block diagram illustrating one embodiment of system components of a network peripheral to filter and aggregate packets. System 200 may include a network peripheral 111 of FIG. 1. In one embodiment, a network peripheral 111 is a chip including a local processor 205 coupled with a local memory 207 to perform packet filtering operations. A network peripheral 111 may include a packet buffer (or receive buffer) 201 storing a packet received from a network interface, such as a wireless radio transceiver 105 of FIG. 1. A packet buffer 201 may be a storage area including one or more pre-designated addressable registers. In some embodiment, a packet buffer may include dynamically allocated memory locations by a local processor 205. A queue pool 203 may be a storage area coupled with a local processor 205 including one or more queues, 209, 211, storing filtered packets. Each queue may include a predetermined size of storage space (e.g. registers or memory space) allocated for a group of packets. In one embodiment, the number of queues and the size of each queue in a queue pool 203 may be dynamically allocated. A bus interface 209 may be coupled to a packet buffer 201 and a queue pool 203 to allow a local processor 205 to send to a host processor, such as host processor 107 of FIG. 1, a received packet either directly from the packet buffer 201 or indirectly from a queue with a group of aggregated packets as a blob.

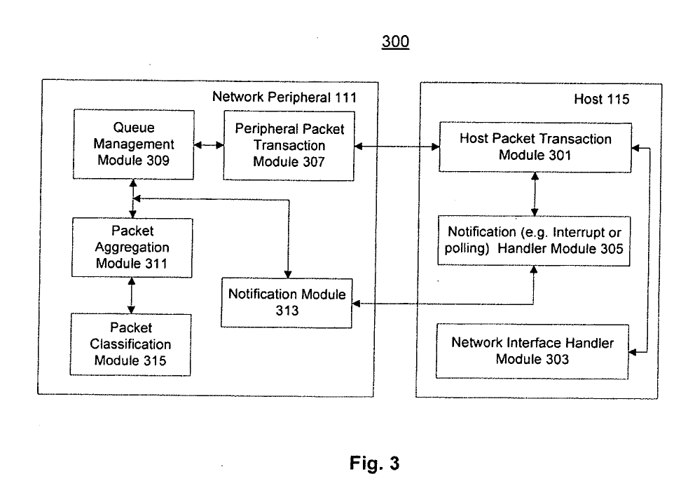

FIG. 3 is a block diagram illustrating one embodiment of system modules to filter and aggregate packets. System 300 may include modules running in a networked system 101 of FIG. 1, such as stored in local memory 207 of FIG. 2 and memory 113 of FIG. 1. In one embodiment, a packet aggregation module 311 filters a received packet to determine whether the packet, such as one buffered in the packet buffer 201 of FIG. 2, should be aggregated. A packet classification module 315 may use the type characteristics of a received packet to assign the packet to one or more packet classes. The packet aggregation module 311 may then use the assigned class(es) to make an aggregation decision. In addition, the assigned class(es) may include a measure of the “degree” of aggregation required or allowed. In one embodiment, the packet aggregation module 311 may also use the assigned classifications to determine which queue in a queue pool is most appropriate for the packet. In another embodiment, a packet classification module 315 includes a packet format parser and a state machine to extract type characteristics from a packet.

A queue management module 309 may select a queue from a queue pool, such as queue pool 203 of FIG. 2, for a packet aggregation module 311 to store a filtered packet. In one embodiment, a queue management module 309 updates a queue after a group of filtered packets stored in the selected queue have been forwarded. A queue management module 309 may allocate memory space in a network peripheral 111 to accommodate queues in a queue pool. A peripheral packet transaction module 307 may perform data transaction operations to forward packets, from either a packet buffer, such as packet buffer 201 of FIG. 2, or a queue, such as queue 209 of FIG. 2, to a host 115 via a local bus, such as local bus 109 of FIG. 1. A notification module 313 may interrupt a host 115 to indicate availability of packets from a network peripheral. In one embodiment, a notification module 313 issues an interrupt request through interrupt lines via a local bus, such as local bus 109 of FIG. 1, to a host processor in a host 115. Interrupts may be carried through sideband channel to a local bus. A notification module 313 may notify a queue management module 309 in response to a polling request from a host 115 to determine if aggregated packets stored in a queue should be sent to the host 115. In one embodiment, a notification module 313 sends out a notification (e.g. an interrupt) at the same time while a peripheral packet transaction module 307 performing data transactions to forward packets, both the notification and the packets being transferred via the same local bus.

According to one embodiment, a host packet transaction module 301 initiates a data transaction from a host 115 with a network peripheral 111 to retrieve network packets from a peripheral packet transaction module 307. In some embodiments, a data transaction may be initiated either from a host or a network peripheral. Packets may be transferred between a network peripheral 111 and a host 115 via a local bus, such as local bus 109 of FIG. 1, according to, for example, an SDIO protocol or other protocols for device interfaces. A notification handler module 305 may notify a host packet transaction module 301 availability of packets from a network peripheral 111. In one embodiment, a notification handler module 305 includes an interrupt (e.g. hardware interrupts) handler. A notification handler module 305 may periodically send polling messages to a notification module 313 to inquire if there are packets ready for retrieving from a network peripheral 111. A network interface handler module 303 may provide layers of network services for applications and/or system services running in a host 115 in response to packets retrieved by a host packet transaction module 301.

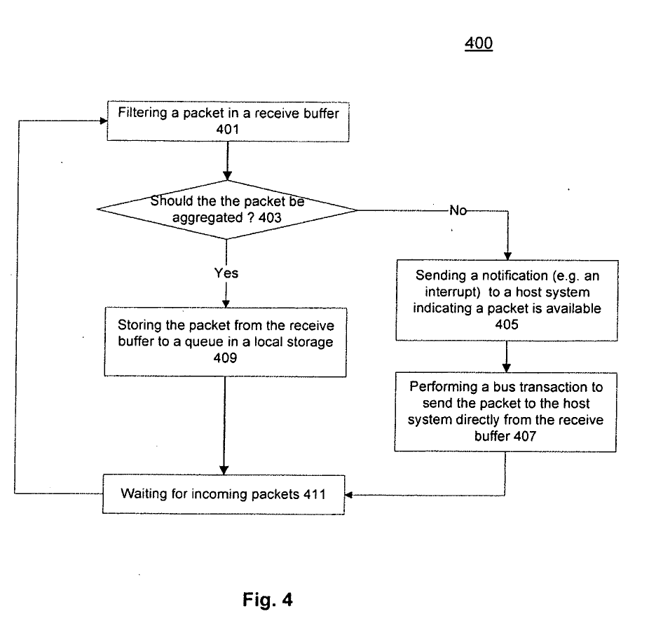

FIG. 4 is a flow diagram illustrating an embodiment of a process to interrupt a host processor for sending non-aggregated packets. Exemplary process 400 may be performed by a processing logic that may include hardware (circuitry, dedicated logic, etc.), software (such as is run on a dedicated machine), or a combination of both. For example, process 400 may be performed by system 300 of FIG. 3. At block 401, according to one embodiment, the processing logic of process 400 filters a packet received in a receive buffer, such as a packet buffer 201 of FIG. 2, from a network receiver, such as a wireless radio transceiver 105 of FIG. 1. Filtering a packet may include determining whether the packet should be aggregated or the degree of aggregation associated with the packet. In one embodiment, the processing logic of process 400 may filter a packet based on a packet aggregation module 311 of FIG. 3. A packet may be network data including headers (and/or trailers) and payloads. Packet headers may specify network control information as an envelope for delivering associated packet payloads, including preformatted fields carrying values such as, for example, source and destination addresses, error detection codes (e.g. checksums), and/or sequencing information for relating a series of packets. In one embodiment, a payload may include additional network data of different network layers. A type characteristics for a packet may include a field value embedded inside the packet.

The processing logic of process 400 may extract header/trailer fields and payloads from a packet to determine whether the packet needs to be aggregated. For example, the processing logic of process 400 may determine that a packet from a certain source address (e.g. IP address and/or port number) should not be aggregated. Alternatively, the processing logic of process 400 may parse packet payloads to identify additional network control information embedded inside payloads for another layer of network. In one embodiment, the processing logic of process 400 identifies network control information across different layers of network inside a packet. Accordingly, the processing logic of process 400 may detect which types of protocols and/or applications a packet is associated with, such as, for example, a multicast, an RTSP (Real-Time Streaming Protocol), an HTTP or a VOIP, etc. In one embodiment, the processing logic of process 400 may match a detected protocol type with a set of predetermined protocols to determine whether a packet should be aggregated. For example, a VOIP packet may not be aggregated to support a targeted VOIP application with low latency, while an HTTP packet may be aggregated to optimize bandwidth usage for local buses.

If a packet is determined to be aggregated at block 403, in one embodiment, the processing logic of process 400 stores a packet from a packet buffer into a local storage (e.g. a queue) within a network peripheral with a group of aggregated packets at block 409. Thus, the packet may be grouped with other aggregated packets without being forwarded to a host directly from a packet buffer right after being received. In one embodiment, the processing logic of process 400 determines which queue to store an aggregated packet according to a degree of aggregation associated with the packet. A degree of aggregation may be a number derived from one or more type characteristics of a packet, or from the class of the packet as determined by the classification module 315 of FIG. 3. The processing logic of process 400 may continue waiting for incoming packets from a network at block 411. If a packet is not aggregated at block 403, the processing logic of process 400 may, at block 405, send a notification, such as asserting an interrupt signal, to a host system to indicate availability of an incoming packet. In some embodiments, a notification may be sent in response to a polling request from a host. The processing logic of process 400 may send a notification according to, for example, a notification module 313 of FIG. 3. Subsequently, at block 407, the processing logic of process 400 may perform a bus transaction with a host system to send a received packet directly from a packet buffer, according to, for example, a packet transaction module 307 of FIG. 3.

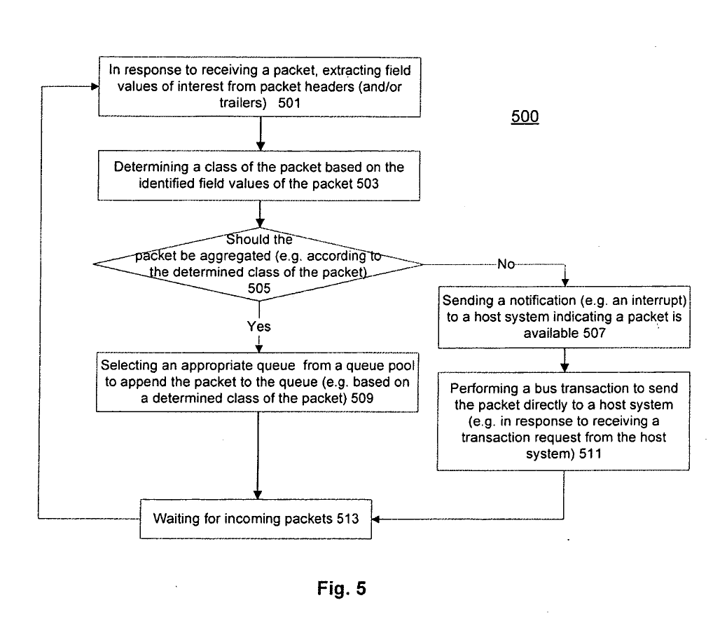

FIG. 5 is a flow diagram illustrating an embodiment of a process to filter packets. Exemplary process 500 may be performed by a processing logic that may include hardware (circuitry, dedicated logic, etc.), software (such as is run on a dedicated machine), or a combination of both. For example, process 500 may be performed by system 300 of FIG. 3. At block 501, according to one embodiment, the processing logic of process 500 extracts field values of interest (e.g. according to one or more settings) from headers and/or trailers of a received packet in a packet buffer, such as a packet buffer 201 of FIG. 2. The processing logic of process 500 may determine a class of a received packet based on one or more extracted field values from the received packet at block 503. Each field of a packet header may be associated with an attribute, e.g. a source address, a protocol name, or a content length, etc. One or more type characteristics may be identified for a packet according to extracted field values. A type or type characteristic for a packet may include a value for an attribute inside the packet. A type may be identified from one or more field values according to a predetermined mapping. In some embodiments, a type is identified from field values dynamically. For example, the processing logic of process 500 may associates an IP address and port number with an HTTP application during run time to determine if subsequently received packets belong to an HTTP application.

At block 505, the processing logic of process 500 may determine whether a packet needs to be aggregated according to the determined class of the packet. In one embodiment, if one of the types identified for a packet belongs to (or matches) filtering criteria, the packet is not aggregated. Filtering criteria may include a set of predetermined types. The processing logic of process 500 may count the number of matching types to determine if a packet needs to be aggregated (e.g. not aggregated if the number of matching types is greater than a predetermined number). In one embodiment, the processing logic of process 400 may determine a packet needs to be aggregated when a status of a local storage, such as a measure of fullness of a queue 209 of FIG. 2, satisfies a preset condition, e.g. 95 percent full.

At block 507, if a packet is not aggregated, the processing logic of process 500 may send a notification to a host system, such as host packet transaction module 301 of FIG. 3, to indicate availability of a received packet. In one embodiment, a notification may direct a host system to retrieve a packet from a packet buffer (e.g. based on a flat setting). The processing logic of process 500 may perform a bus transaction to send a received packet to a host system directly from a packet buffer without moving the received packet to a local storage in a network peripheral, such as queue pool 203 of FIG. 2. In one embodiment, a bus transaction may be performed in response to a transaction request received from a host system. If a packet is aggregated at block 509, the processing logic of process may select a queue from a pool of queues allocated in a local storage within a network peripheral, such as queue pool 203 of FIG. 2, for storing a packet received in a packet buffer. In one embodiment, the processing logic of process 500 selects a queue which is the least full among a pool of queues allocated. The processing logic of process 500 may select a queue which is the eldest in age among a pool of queues. In one embodiment, the age of a queue may be the longest duration a packet has been stored among all packets currently in the queue. The processing logic of process 500 may append a received packet into a selected queue to group the received packet with other existing packets inside the queue. In one embodiment, the processing logic of process 500 directs packets of a particular type or class to a particular queue. At block 513, the processing logic of process 500 continues waiting for incoming packets without notifying a host system to retrieved locally stored packets.

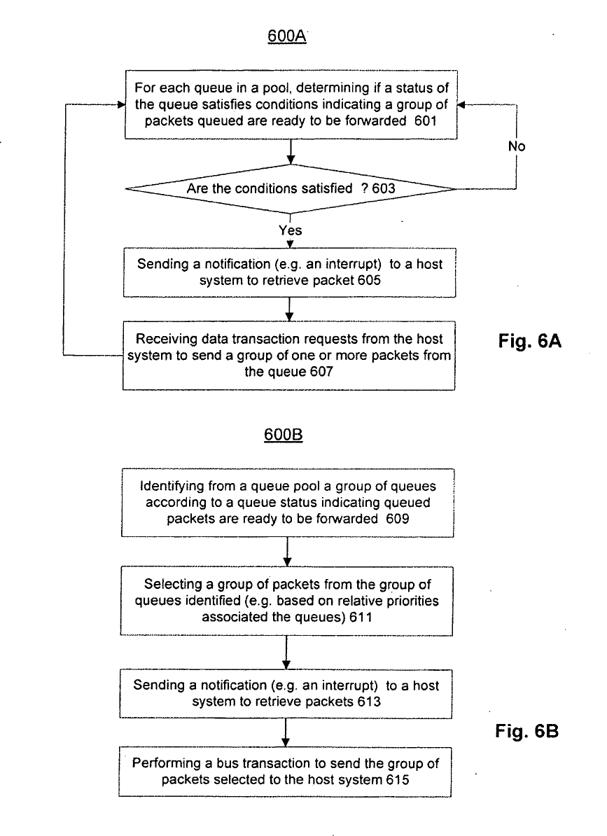

FIG. 6A is a flow diagram illustrating an embodiment of a process to forward aggregated packets to a host processor. Exemplary process 600A may be performed by a processing logic that may include hardware (circuitry, dedicated logic, etc.), software (such as is run on a dedicated machine), or a combination of both. For example, process 600A may be performed by system 300 of FIG. 3. At block 601, according to one embodiment, the processing logic of process 600A may determine if the status for each queue in a pool of queues allocated in a local storage of a network peripheral, such as queue pool 203 of FIG. 2, satisfies one or more conditions for forwarding a group of packets stored inside a queue. In one embodiment, the processing logic of process 600A may determine whether to forward a group of packets from a queue to a host system in response to a polling message received from the host system. In another embodiment, the processing logic of process 600A may perform operations at block 601 periodically according to a preset schedule.

The status of a queue may include a measure of fullness of a queue, such as the percentage of storage space occupied by existing packets stored (queued) inside the queue. In one embodiment, the status may include an age of the queue. Alternatively, the status may include the type or class of the packets stored inside the queue. A condition indicating a group of packets stored in a queue are ready to be forwarded may be satisfied if a measure of fullness and/or an age exceed certain predetermined or dynamically determined thresholds. In some embodiments, a threshold for a condition is dynamically adjusted according to types of packets stored inside a queue.

If one or more conditions to forward packets from a queue are satisfied at block 603, the processing logic of process 600A may send a notification to a host system, such as host 115 of FIG. 1, to retrieve the packets stored inside the queue. A notification message may be, for example, an interrupt request. In one embodiment, a notification message is a message from a network peripheral responding to a polling message from a host system. A notification may include an indication of a queue storing packets ready to forward. Subsequently at block 607, the processing logic of process 600 may receive data transaction requests from a host system to send a group of one or more packets from the queue. A group of packets may be forwarded from a network peripheral to a host system in one single data (or bus) transaction according to available bandwidth of a local bus coupling the network peripheral and the host system, such as local bus 109 of FIG. 1. In one embodiment, the processing logic of process 600A may forward one or more groups of packets from a queue to empty the queue. Alternatively, a portion of packets from the queue may be forwarded according to a queuing order. In some embodiment, the processing logic of process 600A may not respond to data transaction requests before status of each of a pool of queue is checked.

FIG. 6B is a flow diagram illustrating an alternative embodiment of a process to forward aggregated packets to a host processor. Exemplary process 600B may be performed by a processing logic that may include hardware (circuitry, dedicated logic, etc.), software (such as is run on a dedicated machine), or a combination of both. For example, process 600B may be performed by system 300 of FIG. 3. At block 609, in one embodiment, the processing logic of process 600B identifies a group of queues from a queue pool, such as queue pool 203 of FIG. 2, whose status indicate that queued packets are ready to be forwarded. The status of each of the identified group of queues may satisfy one or more conditions indicating packets stored inside the queue are ready to be forwarded. At block 611, the processing logic of process 600B may select a group of packets to forward from the identified group of queues. The order in which packets are forwarded from the group of queues may be based on the relative priorities of the queues that are ready to forward packets. In one embodiment, packets may be forwarded from higher priority queues first. In another embodiment, the group of packets to forward may include packets from multiple queues, with higher priority queues being emptied first. In some other embodiment, the group of packets to forward may also include packets from multiple queues, with packets from the highest priority queue making up the highest percentage of the group, packets from the next-highest priority queue making up the next highest percentage of the group, and so on. The processing logic of process 600B may send a notification to a host system to retrieve the packets stored inside the queue at block 613. Subsequently at block 615, the processing logic of process 600B may send the selected group of packets to the host system in one single bus transaction in response to data transaction requests received from the host system.

The priority of a queue may be predetermined, or may be adjusted dynamically based on current information about the queue and the system environment In one embodiment, the priority may be adjusted to account for the age and/or fullness of the queue. In another, the priority may be dynamically adjusted based on the type of packets in the queue. In some other embodiment, the priority may be adjusted based on a prediction of how soon the queue will be filled given recent traffic conditions, or on an estimation of the load on the host system.

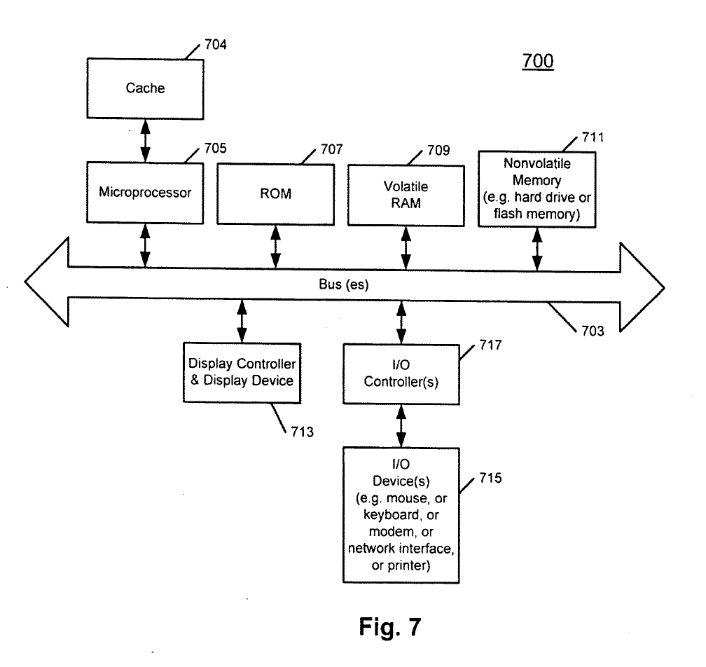

FIG. 7 shows one example of a data processing system which may be used with one embodiment the present invention. For example, the system 700 may be implemented including a host as shown in FIG. 1. Note that while FIG. 7 illustrates various components of a computer system, it is not intended to represent any particular architecture or manner of interconnecting the components as such details are not germane to the present invention. It will also be appreciated that network computers and other data processing systems which have fewer components or perhaps more components may also be used with the present invention.

As shown in FIG. 7, the computer system 700, which is a form of a data processing system, includes a bus 703 which is coupled to a microprocessor(s) 705 and a ROM (Read Only Memory) 707 and volatile RAM 709 and a non-volatile memory 711. The microprocessor 705 may retrieve the instructions from the memories 707, 709, 711 and execute the instructions to perform operations described above. The bus 703 interconnects these various components together and also interconnects these components 705, 707, 709, and 711 to a display controller and display device 713 and to peripheral devices such as input/output (I/O) devices which may be mice, keyboards, modems, network interfaces, printers and other devices which are well known in the art. Typically, the input/output devices 715 are coupled to the system through input/output controllers 717. The volatile RAM (Random Access Memory) 709 is typically implemented as dynamic RAM (DRAM) which requires power continually in order to refresh or maintain the data in the memory.

The mass storage 711 is typically a magnetic hard drive or a magnetic optical drive or an optical drive or a DVD RAM or a flash memory or other types of memory systems which maintain data (e.g. large amounts of data) even after power is removed from the system. Typically, the mass storage 711 will also be a random access memory although this is not required. While FIG. 7 shows that the mass storage 711 is a local device coupled directly to the rest of the components in the data processing system, it will be appreciated that the present invention may utilize a non-volatile memory which is remote from the system, such as a network storage device which is coupled to the data processing system through a network interface such as a modem, an Ethernet interface or a wireless network. The bus 703 may include one or more buses connected to each other through various bridges, controllers and/or adapters as is well known in the art.

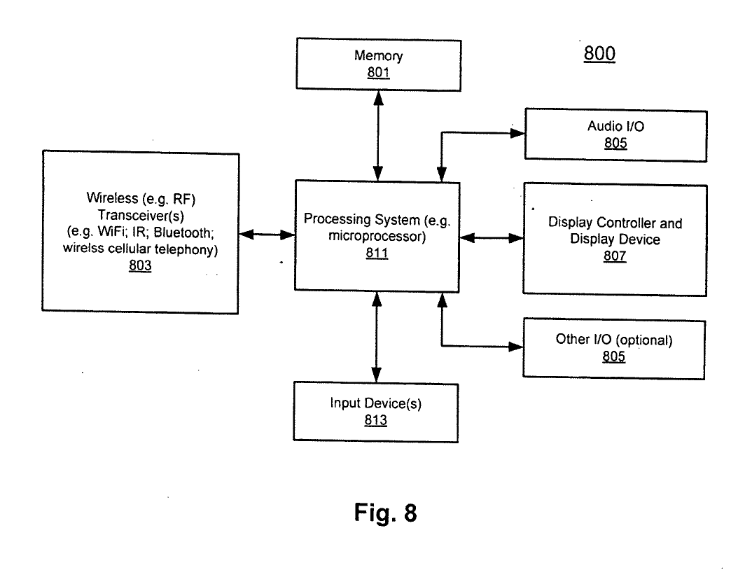

FIG. 8 shows an example of another data processing system which may be used with one embodiment of the present invention. For example, system 800 may be implemented as part of system as shown in FIG. 1. The data processing system 800 shown in FIG. 8 includes a processing system 811, which may be one or more microprocessors, or which may be a system on a chip integrated circuit, and the system also includes memory 801 for storing data and programs for execution by the processing system. The system 800 also includes an audio input/output subsystem 805 which may include a microphone and a speaker for, for example, playing back music or providing telephone functionality through the speaker and microphone.

A display controller and display device 807 provide a visual user interface for the user; this digital interface may include a graphical user interface which is similar to that shown on an iPhone® phone device or on a Macintosh computer when running OS X operating system software. The system 800 also includes one or more wireless transceivers 803 to communicate with another data processing system. A wireless transceiver may be a WiFi transceiver, an infrared transceiver, a Bluetooth transceiver, and/or a wireless cellular telephony transceiver. It will be appreciated that additional components, not shown, may also be part of the system 800 in certain embodiments, and in certain embodiments fewer components than shown in FIG. 8 may also be used in a data processing system.

The data processing system 800 also includes one or more input devices 813 which are provided to allow a user to provide input to the system. These input devices may be a keypad or a keyboard or a touch panel or a multi touch panel. The data processing system 800 also includes an optional input/output device 815 which may be a connector for a dock. It will be appreciated that one or more buses, not shown, may be used to interconnect the various components as is well known in the art. The data processing system shown in FIG. 8 may be a handheld computer or a personal digital assistant (PDA), or a cellular telephone with PDA like functionality, or a handheld computer which includes a cellular telephone, or a media player, such as an iPod, or devices which combine aspects or functions of these devices, such as a media player combined with a PDA and a cellular telephone in one device. In other embodiments, the data processing system 800 may be a network computer or an embedded processing device within another device, or other types of data processing systems which have fewer components or perhaps more components than that shown in FIG. 8.

At least certain embodiments of the inventions may be part of a digital media player, such as a portable music and/or video media player, which may include a media processing system to present the media, a storage device to store the media and may further include a radio frequency (RF) transceiver (e.g., an RF transceiver for a cellular telephone) coupled with an antenna system and the media processing system. In certain embodiments, media stored on a remote storage device may be transmitted to the media player through the RF transceiver. The media may be, for example, one or more of music or other audio, still pictures, or motion pictures.

The portable media player may include a media selection device, such as a click wheel input device on an iPhone®, an iPod® or iPod Nano® media player from Apple Computer, Inc. of Cupertino, Calif., a touch screen input device, pushbutton device, movable pointing input device or other input device. The media selection device may be used to select the media stored on the storage device and/or the remote storage device. The portable media player may, in at least certain embodiments, include a display device which is coupled to the media processing system to display titles or other indicators of media being selected through the input device and being presented, either through a speaker or earphone(s), or on the display device, or on both display device and a speaker or earphone(s). Examples of a portable media player are described in published U.S. patent application numbers 2003/0095096 and 2004/0224638, both of which are incorporated herein by reference.

Portions of what was described above may be implemented with logic circuitry such as a dedicated logic circuit or with a microcontroller or other form of processing core that executes program code instructions. Thus processes taught by the discussion above may be performed with program code such as machine-executable instructions that cause a machine that executes these instructions to perform certain functions. In this context, a “machine” may be a machine that converts intermediate form (or “abstract”) instructions into processor specific instructions (e.g., an abstract execution environment such as a “virtual machine” (e.g., a Java Virtual Machine), an interpreter, a Common Language Runtime, a high-level language virtual machine, etc.), and/or, electronic circuitry disposed on a semiconductor chip (e.g., “logic circuitry” implemented with transistors) designed to execute instructions such as a general-purpose processor and/or a special-purpose processor. Processes taught by the discussion above may also be performed by (in the alternative to a machine or in combination with a machine) electronic circuitry designed to perform the processes (or a portion thereof) without the execution of program code.

The present invention also relates to an apparatus for performing the operations described herein. This apparatus may be specially constructed for the required purpose, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), RAMs, EPROMs, EEPROMs, magnetic or optical cards, or any type of media suitable for storing electronic instructions, and each coupled to a computer system bus.

A machine readable medium includes any mechanism for storing or transmitting information in a form readable by a machine (e.g., a computer). For example, a machine readable medium includes read only memory (“ROM”); random access memory (“RAM”); magnetic disk storage media; optical storage media; flash memory devices; electrical, optical, acoustical or other form of propagated signals (e.g., carrier waves, infrared signals, digital signals, etc.); etc.

An article of manufacture may be used to store program code. An article of manufacture that stores program code may be embodied as, but is not limited to, one or more memories (e.g., one or more flash memories, random access memories (static, dynamic or other)), optical disks, CD-ROMs, DVD ROMs, EPROMs, EEPROMs, magnetic or optical cards or other type of machine-readable media suitable for storing electronic instructions. Program code may also be downloaded from a remote computer (e.g., a server) to a requesting computer (e.g., a client) by way of data signals embodied in a propagation medium (e.g., via a communication link (e.g., a network connection)).

The preceding detailed descriptions are presented in terms of algorithms and symbolic representations of operations on data bits within a computer memory. These algorithmic descriptions and representations are the tools used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be kept in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The processes and displays presented herein are not inherently related to any particular computer or other apparatus. Various general-purpose systems may be used with programs in accordance with the teachings herein, or it may prove convenient to construct a more specialized apparatus to perform the operations described. The required structure for a variety of these systems will be evident from the description below. In addition, the present invention is not described with reference to any particular programming language. It will be appreciated that a variety of programming languages may be used to implement the teachings of the invention as described herein.

The foregoing discussion merely describes some exemplary embodiments of the present invention. One skilled in the art will readily recognize from such discussion, the accompanying drawings and the claims that various modifications can be made without departing from the spirit and scope of the invention.

What is claimed is:

1. A computer implemented method, comprising:
in response to receiving a packet into a buffer, determining whether the packet is to be aggregated;
if the packet is determined not to be aggregated, interrupting a host system including a host processor via a local bus to indicate availability of the packet; and
sending the packet to the interrupted host system via the local bus directly from the buffer.

2. The method of claim 1, wherein the packet includes packet headers, the determination comprising:
selecting one or more fields from the packet headers; and
comparing the selected fields with a set of filtering criteria including one or more packet field values.

3. The method of claim 2, wherein the packet includes packet payloads, further comprising:
detecting one or more protocol identifiers from the packet payloads; and
comparing the detected protocol identifiers with the set of filtering criteria.

4. The method of claim 2, wherein the selected fields include a source address.

5. The method of claim 1, wherein the host system includes an interrupt flag coupled with the host processor, the interruption of the host system comprising:
asserting the interrupt flag in the host system via the local bus; and
receiving a transaction request from the interrupted host processor over the local bus wherein the packet data is sent from the buffer in response to the transaction request.

6. The method of claim 1, wherein the interruption of the host system comprises:
detecting a polling request from the host processor via the local bus; and
sending a polling response indicating the availability of the packet to the host processor.

7. The method of claim 1, further comprising:
if the packet is determined to be aggregated, storing the packet from the buffer into a queue storing filtered packets.

8. The method of claim 7, wherein the queue includes a status based on the filtered packets, further comprising:
determining if the status satisfies a condition to forward the filtered packets from the queue;
if the condition is determined satisfactory, interrupting the host system to indicate availability of the filtered packet; and
sending a blob including at least a part of the filtered packet to the interrupted host system from the queue.

9. The method of claim 8, wherein the status includes duration of time since at least one of the filtered packets has been stored in the queue.

10. A machine-readable medium having instructions, which when executed by a machine, cause a machine to perform a method, the method comprising:
in response to receiving a packet into a buffer, determining whether the packet is to be aggregated;
if the packet is determined not to be aggregated, interrupting a host system including a host processor via a local bus to indicate availability of the packet; and
sending the packet to the interrupted host system via the local bus directly from the buffer.

11. The method of claim 10, wherein the packet includes packet headers, the determination comprising:
selecting one or more fields from the packet headers; and
comparing the selected fields with a set of filtering criteria including one or more packet field values.

12. The method of claim 11, wherein the packet includes packet payloads, further comprising:
detecting one or more protocol identifiers from the packet payloads; and
comparing the detected protocol identifiers with the set of filtering criteria.

13. The method of claim 12, wherein the detected protocol identifiers include an HTTP protocol identifier.

14. The method of claim 10, wherein the host system includes an interrupt flag coupled with the host processor, the interruption of the host system comprising:
asserting the interrupt flag in the host system via the local bus; and
receiving a transaction request from the interrupted host processor over the local bus wherein the packet data is sent from the buffer in response to the transaction request.

15. The method of claim 10, wherein the interruption of the host system comprises:
detecting a polling request from the host processor via the local bus; and
sending a polling response indicating the availability of the packet to the host processor.

16. The method of claim 10, further comprising:
if the packet is determined to be aggregated, storing the packet from the buffer into a queue storing filtered packets.

17. The method of claim 16, wherein the queue includes a status based on the filtered packets, further comprising:
determining if the status satisfies a condition to forward the filtered packets from the queue;
if the condition is determined satisfactory, interrupting the host system to indicate availability of the filtered packet; and
sending a blob including at least a part of the filtered packet to the interrupted host system from the queue.

18. The method of claim 17, wherein the status includes a size of the queue.

19. A data processing system, comprising:
a host processor;
a bus coupled to the host processor;
a network interface processor coupled to the bus, the network interface processor being configured:
in response to receiving a packet into a buffer, to act as a filter to determine whether the packet is to be aggregated;
if the packet is determined not to be aggregated, to issue an interrupt to the host processor via the local bus to indicate availability of the packet data; and
to send the packet to the host processor via the local bus directly from the buffer during a data transaction requested by the host processor responding to the interrupt.

20. The data processing system of claim 13, wherein the network interface processor being further configure to:
if the packet is determined to be aggregated, select a queue from a pool of queues including filtered packet; and
to store the packet into the selected queue.
